(19) United States
(12) Patent Application Publication
(10) Pub. No.: US 2006/0212279 A1
(43) Pub. Date: Sep. 21, 2006

(54) Methods for efficient solution set optimization

(75) Inventors: David E. Goldberg, Champaign, IL (US); Kumara Sastry, Champaign, IL (US); Martin Pelikan, Maryland Heights, MO (US)

Correspondence Address: GREER, BURNS & CRAIN, 300 S WACKER DR, 25TH FLOOR, CHICAGO, IL, 60606, US

(73) Assignees: The Board of Trustees of the University of Illinois and; The Curators of the University of Missouri.

(21) Appl. No.: 11/343,195

(22) Filed: Jan. 30, 2006

Related U.S. Application Data
(60) Provisional application No. 60/648,642, filed on Jan. 31, 2005.

(51) Int. Cl. G06F 17/10

(52) U.S. Cl. 703/2

(57) ABSTRACT

A method for optimizing a solution set comprises the steps of generating an initial solution set, identifying a desirable portion of the initial solution set using a fitness calculator, using the desirable portion to create a surrogate fitness model that is computationally less expensive than the fitness calculator, generating new solutions, replacing at least a portion of the initial solution set with the new solutions to create a second solution set, and evaluating at least a portion of the second solution set with the fitness surrogate model to identify a second desirable portion.

### CROSS REFERENCE

The present invention claims priority on U.S. Provisional Patent Application No. 60/648,642 filed Jan. 31, 2005; which application is incorporated by reference herein.

### STATEMENT OF GOVERNMENT INTEREST

This invention was made with Government support under Contract Number F49620-03-1-0129 awarded by AFOSR; Contract Number DMR-99-76550 and DMR-01-21695 awarded by NSF; and Contract Number DEFG02-91ER45439 awarded by DOE. The Government has certain rights in the invention

### FIELD OF THE INVENTION

The present invention is related to methods, computer program products, and systems for optimizing solution sets.

### BACKGROUND OF THE INVENTION

Many real-world problems have enormously large potential solution sets that require optimizations. Optimal designs for bridges, potential trajectories of asteroids or missiles, optimal molecular designs for pharmaceuticals, optimal fund distribution in financial instruments, and the like are just some of the almost infinite variety of problems that can provide a large set of potential solutions that need to be optimized. In these and other example, the solution space can reach millions, hundreds of millions, billions, or even tens of digits or more of potential solutions for optimization. For example, when optimizing a problem that has a 30 bit solution, the potential solution space is a billion. Under these circumstances, random searching or enumeration of the entire search space of such sets is not practical. As a result, efforts have been made to develop optimization methods for solving the problems efficiently. To date, however, known optimization methods have substantial limitations.

Some optimization methods follow a general scheme of taking a set of potential solutions, evaluating them using some scoring metric to identify desirable solutions from the set, and determining if completion criteria are satisfied. If the criteria are satisfied, the optimization ends. If not, a new solution set is generated or evolved, often based on the selected desirable solutions, and the method is repeated. Iterations continue until completion criteria are satisfied. For complex or large problems, iterations may continue for relatively long periods of time, and may otherwise consumer considerable computational resources.

One example problem resulting in difficulties with the use of these and other optimization methods is the evaluation step of identifying promising solutions from a solution set. When faced with a large-scale problem the step of evaluating the fitness or quality of all of the solutions can demand high computer resources and execution times. For large-scale problems, the task of computing even a sub quadratic number of function evaluations can be daunting. This is especially the case if the fitness evaluation is a complex simulation, model, or computation. This step often presents a time-limiting “bottleneck” on performance that makes use of the optimization method impractical for some applications.

Some proposals have been made to speed this step. One is evaluation relaxation, where an accurate, but computationally-expensive fitness evaluation is replaced with a less accurate, but computationally inexpensive fitness estimate. The lower-cost, less-accurate fitness estimate can either be (1) “exogenous,” as in the case of surrogate (or approximate) fitness functions, where, external means can be used to develop the fitness estimate, or (2) “endogenous,” as in the case of fitness inheritance, where the fitness estimate is computed internally based on parental fitnesses.

While the use of exogenous models has been empirically and analytically studied, limited attention has been paid towards analysis and development of competent methods for building endogenous fitness estimates. Moreover, the endogenous models used in evolutionary-computation of the prior art tend to be naive and have been shown to yield only limited speed-up, both in single-objective and multi objective cases. Endogeneous models have been limited to “rigid” solutions that are pre-defined, with an example being that all offspring have a fitness set at the average of their parents.

While many evaluation-relaxation studies employ external means for developing and deriving surrogate fitness functions, there is also a class of evaluation-relaxation, called fitness inheritance, in which fitness values of parents are used to assign fitness to their offspring. To date, however, these proposals have been relatively limited in their design and development, and have met with only limited success. Unresolved problems in the art therefore exist.

### SUMMARY

A method for optimizing a solution set comprises the steps of, not necessarily in the sequence listed, creating an initial solution set, identifying a desirable portion of the initial solution set using a fitness calculator, creating a model that is representative of the desirable portion, using the model to create a surrogate fitness estimator that is computationally less expensive than the fitness calculator, generating new solutions, replacing at least a portion of the initial solution set with the new solutions to create a new solution set, and evaluating at least a portion of the new solution set with the fitness surrogate estimator to identify a new desirable portion.

### BRIEF DESCRIPTION OF THE FIGURES

FIG. 1 is a flowchart illustrating one example embodiment of the invention;

FIG. 2 is a representative conditional probability table using traditional representation (FIG. 2(a)) as well as local structures (FIGS. 2(b) and (c)) that are useful to illustrate example embodiments of the invention;

FIG. 3 illustrates fitness inheritance in a conditional probability table (FIG. 3(a)) and its representation using local structures (FIG. 3(b) and (c)) that are useful to illustrate embodiments of the invention;

FIG. 4 illustrates a verification of a population-size-ratio model and convergence-time-ratio model for various values of pᵢ with empirical results that are useful to illustrate embodiments of the invention;

FIG. 5 illustrates the effect of using a fitness surrogate model of the invention on the total number of function evaluations and the speed-up verification for eCGA by using a fitness surrogate model according to an example method of the invention; and,

FIG. 6 illustrates the effect of an example step of using a fitness surrogate model on the total number of function evaluations required for BOA and the speed-up obtained by using a surrogate fitness method of the invention with BOA.

### DETAILED DESCRIPTION

Embodiments of the present invention are directed to methods and program products for optimizing a solution set for a problem. Those knowledgeable in the art will appreciate that embodiments of the present invention lend themselves well to practice in the form of computer program products. Accordingly, it will appreciated that embodiments of the invention may comprise computer program products comprising computer executable instructions stored on a computer readable medium that when executed cause a computer to undertake certain steps. Other embodiments of the invention include systems for optimizing a solution set, with an example being a processor based system capable of executing instructions that cause it to carry out a method of the invention. It will accordingly be appreciated that description made herein of a method of the invention may likewise apply to a program product of the invention and/or to a system of the invention.

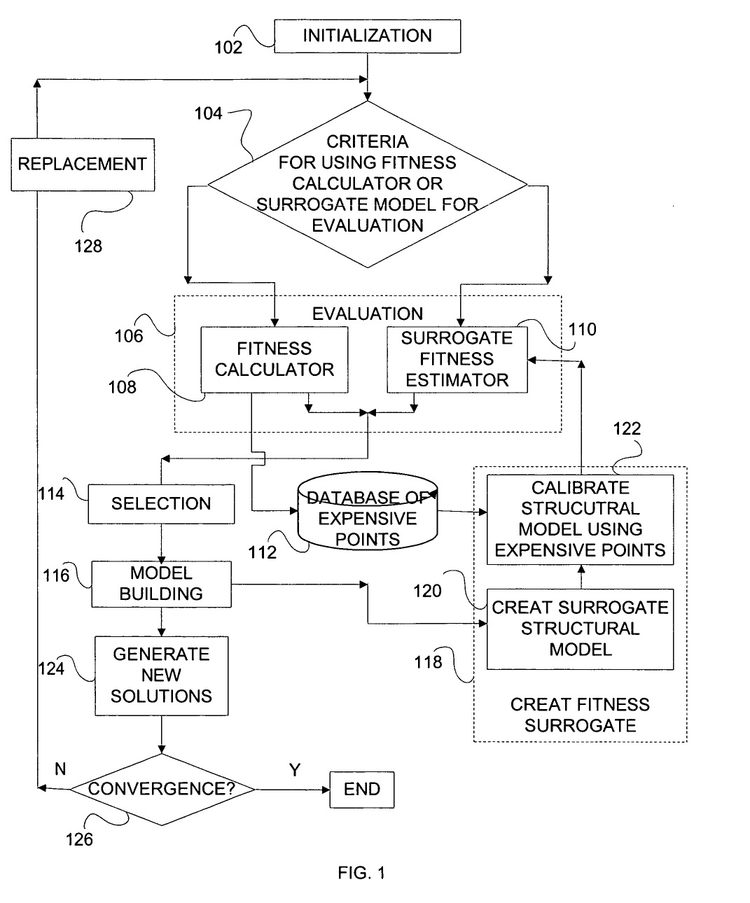

FIG. 1 is a flowchart illustrating one example embodiment of a method and program product 100 of the invention. A solution set is first initialized. Block 102. Initialization may include, for example, creating a solution set including a plurality of members. In some applications, creating an initial solution set may comprise defining a solution set through a one or more rules or algorithms. For example, initialization may include defining a solution set as including all possible bit strings of length 6 bits, with the result that the solution set includes 2⁶ members. In many real world applications, the size of the overall solution space may number into the millions, billions or more. In such cases, a step of creating an initial solution set may include, for example, sampling the solution space to select an initial solution set of reasonable size. Sampling may be performed through any of a number of steps, including random sampling, statistical sampling, probabilistic sampling, and the like. Different problems and approaches may lead to differently population sizes for the initial solution set. By way of example only, in a 10×4 trap function problem, the solution space has a total of 2⁴⁰ different potential solutions. When optimizing such a solution through a method of the invention, an initial solution set may be created of a population size of about 1600 through random or other sampling of the solution space.

It will be appreciated that the individual members of the solution set may be potential solutions to any of a wide variety of real world problems. For example, if the problem at hand is the optimal design of a large electrical circuit, the solutions may be particular sequences and arrangements of components in the circuit. If the problem at hand is optimal distribution of financial funds, the solutions may be different distribution percentages between different investments. If the problem at hand is the optimal design of a bridge, the solutions may specify a material of construction, dimensions, support placement, and the like. If the problem at hand is the optimal process for making a pharmaceutical, the solutions may be different sequences of chemical reaction, different temperatures and pressures, and different reactant compounds.

Referring again to FIG. 1, the method 100 next applies a decision criteria of whether a fitness calculator should be used to calculate fitness or a surrogate fitness model to estimate fitness. Block 104. The fitness calculator is computationally more expensive and therefore requires more execution time than the fitness surrogate, but generally offers greater precision. As used herein, the terms “calculate” and “estimate” when used in the context of evaluation of block 104 (and 106) are both intended to broadly refer to a determination of fitness. The two different terms are used for clarity and convenience with the intention that it be understood that the fitness “estimation” comes at a lower computational cost than the fitness “calculation.” Also, those knowledgeable in the art will appreciate that “fitness” generally refers to how good a candidate solution is with respect to the problem at hand. Fitness may also be thought of as solution quality, and fitness evaluation therefore thought of as solution quality assessment or an objective value evaluation. It will also be appreciated that the concept of computational expense as used in this context is intended to broadly refer to required processing power. Given a particular processor, for example, an expensive computation requires more time using a given processor than does a less costly computation.

In many real world problems of considerable size, the time difference over the large solution set between execution using the computationally expensive fitness calculator and the less computationally expensive fitness surrogate model will be significant, as detailed herein below. Accordingly, some balance must be achieved between accuracy of fitness determination and computational resources consumed. The decision criteria of block 104 are useful to achieve this balance.

Decision criteria may include, for example, a rule that defines which iterations to use the fitness evaluator on. For example, in some invention embodiments the expensive fitness calculator is used on a first iteration, and the less expensive fitness surrogate model on all subsequent iterations. Other example criteria are statistical or probabilistic criteria. For example, some fixed percentage X %, with examples being X % =between about 99% and about 90%, between about 95% and 99%, between about 99% and about 75%, between about 100% and 90%, between about 100% and 75%, of the initial (and/or subsequent) solution set may be evaluated with the surrogate fitness model and the remaining (100-X)% with the expensive fitness calculator.

Combinations of one or more criteria may be used. For example, 25% of the first solution set may be evaluated using the expensive fitness calculator, 20% of the second through n^{th} (where n might be 5, 10 or 50, for example), and 10% all on subsequent iterations. In these examples, decision criteria have taken advantage of some fixed or static rule to define what portion of the solution set is evaluated using the expensive fitness calculator and what portion is evaluated with the less costly fitness surrogate model (e.g., 25% on first iteration, 20% on second-n^{th}, and 10% on all subsequent).

In addition to these static rules, the present invention can include decision criteria that change dynamically in response to the quality of the desirable portion identified in the subsequent step of evaluation (block 106), or on other changing factors. For example, if the quality of the desirable portion exceeds some limit, the portion evaluated using the expensive calculator can be decreased and that evaluated using the less expensive fitness surrogate model increased to speed computation. If, on the other hand, the quality is below some limit, the portion evaluated using the expensive calculator increased and the inexpensive fitness surrogate decreased thereby slowing computation but presumably increasing accuracy.

Referring now to the step of evaluation (block 106), one or both of the expensive fitness calculator (block 108) and the fitness surrogate estimator (block 110) are used to evaluate the fitness of solutions from the initialized solution set based on the criteria decision made in block 104. Fitness calculation or estimation using either of the fitness calculator (block 108) or the surrogate fitness estimator (block 110) can result in a scalar number, a vector, or other value or set of values.

The expensive fitness calculator may comprise, for example, a relatively complex calculation or series of calculations. If the problem at hand is the optimal design of a bridge, for instance, the expensive fitness calculator may solve a series of integrations, differential equations and other calculations to determine a resultant bridge weight, location of stress points, and maximum deflection based on an input solution string. Use of the expensive fitness calculator in block 108 may therefore require substantial computational resources and time. This is particularly the case when a large number of solutions must be evaluated.

The surrogate fitness estimator of block 110 can be a relatively simple model of fitness when compared to the fitness calculator of block 108. Use of the surrogate model or estimator in block 110 therefore can offer substantial computational resource and time savings, particularly when faced with large solution sets to be evaluated. It is noted that herein the surrogate fitness estimator of block 108 may alternately be referred to as a surrogate fitness model. The term “estimator” is used for convenience and clarity as explained above.

The illustrative method also includes a step of saving some or all of the solution points evaluated using the expensive fitness calculator. Block 112. In some invention embodiments, all of the points evaluated by the expensive calculator or evaluator (block 108) are stored, while in other embodiments, only some are stored. The data stored may include, for example, the input solution and the resultant output when the input solution is evaluated using the expensive fitness calculator. For example, if the input solution is a bit string of length 6 and the expensive fitness evaluator is a combination of a scalar and a vector determined using the input bit string solution, the step of storing may include storing the input string together with the output scalar and vector. This data will be used in a subsequent step to create the surrogate fitness model as will be detailed below. For convenience, the stored data points have been referred to as “expensive” points in FIG. 1, block 112, to indicate that they result from the expensive fitness calculator of block 108. This data may also be referred to herein as “fitness calculation data points.”

A step of selection is then performed. Block 114. Selection may include, for example, selecting a high scoring portion of the evaluated solutions. Selection may require some scoring metric to be provided that defines which evaluations are preferred over others. For example, if fitness evaluation simply results in a single numerical fitness value, one simple scoring metric can be that a high fitness value is preferred over a low value. More complex scoring metrics can also apply. Referring once again to the bridge design hypothetical solutions, a scoring metric may be some combination of a minimized total bridge weight, stress points located close to the ends of the bridge, and a minimized total deflection.

Model building is then performed in block 116. In an example step of model building, a predictive model is constructed using the desirable portion selected in block 114. Many different models will be useful in practice of the invention. The model should be representative in some manner of the desirable solutions. Preferably, the model will include variables, at least some of which interact with one another. The model also preferably provides some knowledge, either implicit or explicit, of a relationship between variables. The model may be, for example, a probabilistic model that models conditional probabilities between variables.

To build the model, a methodology is first selected to represent the model itself. Various representations such as marginal product models, Bayesian networks, decision graphs, models utilizing probability tables, directed graphs, statistical studies, and the like. By way of more particular example, embodiments of the invention have proven useful when using such models as one or more of the Bayesian Optimization Algorithm (BOA), the Compact Genetic Algorithm (CGA), and the extended Compact Genetic Algorithm (eCGA). Other models suitable for use in methods of the invention include dependency structure matrix driven genetic algorithm (DMSGA), linkage identification by nonlinearity check (LINC), linkage identification by monotonicity detection (LIMD), messy genetic algorithm (mGA), fast messy genetic algorithm (fmGA), gene expression messy genetic algorithm (GEMGA), linkage learning genetic algorithm (LLGA), estimation of distribution algorithms (EDAs), generalized principal component analysis (GPCA), and non-linear principal component analysis (NLPCA). These and other suitable models are well known to those knowledgeable in the art, and a detailed description is therefore not necessary herein. Preferably, the representation scheme defines a class of probabilistic models that can represent the promising solutions.

Once the model has been built in block 116, the illustrative embodiment of FIG. 1 creates a surrogate fitness model in block 118. In the illustrative method 100, creation of the surrogate first includes in block 120 creating a surrogate structural model. As used herein, the terms “structure,” “structural,” and “structured” when used in this context are intended to be broadly interpreted as referring to inferred or defined relations between variables. A cubic or quadratic polynomial equation that includes variables and constant coefficients (even if the value of the constant coefficients are unknown), for instance, may be considered a “structural” model. The step 120 of building a structural surrogate model from the probabilistic model may include, for instance, inferring, deducing, or otherwise extracting knowledge of interaction of variables in the probabilistic model and using this knowledge to create the structural model.

In one illustrative example, the model built in the step of block 116 will include variables, at least some of which interact with others. The step of creating a structural model of block 118 can then include using the knowledge of interaction of variables from the model. The form of the structural model might then be groupings of variables that are known to interact with one another.

By way of additional example, if a simple probability model built in block 116 suggested that desirable solutions might be a particular set of strings of bits with probabilities predicting promising positions for 1's and 0's, the step of creating a structured surrogate fitness model from these predicted promising bit strings can include determining which bits appear to interact with one another. The 1's and 0's in the various strings could be replaced in the structural model with variables, with the knowledge of which variables interact with which other variables useful to relate the variables to one another. A polynomial structural surrogate model may then result.

The particular structure of the structural fitness surrogate model will depend on the particular type of model built in block 116. For example, if a probability model is built that includes a probability table(s) or matrice(s), the position of the probability terms in the table(s) or matrice(s) can be mapped into the structural model. If the model built can be expressed in a graphical model of probabilities, the conditional probabilities indicated by the graph can be used to relate variables to one another. Examples of this include BOA. Mapping of a probability model's program subtrees into polynomials over the subtrees is still another example of creating a structural model from the model built in block 116.

The step of block 120 can include creating a structural surrogate model through steps of performing a discovery process, analysis, inference, or other extraction of knowledge to discover the most appropriate form of the structural surrogate. A genetic program could be used for this step, for example. Weighted basis functions are other examples of useful structural surrogate models, with particular weighted basis functions including orthogonal functions such as Fourier, Walsh, wavelets, and others.

After the illustrative step of creating the surrogate structural model of block 120, the surrogate model is calibrated using the stored expensive fitness calculator output of block 110 in block 122. Calibration may include, for example, adjusting the structural model to improve its ability to predict or model desirable output. Steps of filtering, estimation, or other calibration may be performed. In other invention embodiments, the structural model created in block 120 may be expressed with unknown parameters or coefficients. The step of calibration of step 122 can then include fitting the parameters or coefficients using the stored expensive fitness calculator output of block 110.

For example, in the illustrative method 100 assume that the structural model created in block 120 is expressed in the form of a polynomial with unknown constant coefficients. These coefficients can be determined through curve fitting in block 122 using the stored expensive fitness calculator output of block 110. A variety of particular steps of fitting the structural model will be useful within the invention, and are generally known. For example, steps may include linear regression using its various extensions, least squares fit, and the like. More sophisticated fitting may also be performed, with examples including use of genetic algorithms, heuristic search, tabu search, and simulated annealing. Those knowledgeable in the art will appreciate that many other known steps of fitting coefficients using stored data points will be useful.

Methods of the invention may also include different steps of using the stored expensive fitness calculator output of block 110. For example, all of the stored points may be used, or only a selected portion. If the expensive fitness calculator of block 108 are used in every or at least in multiple iterations of the method 100, only the most recently generated stored expensive fitness calculator output in block 110 might be used, with particular examples being the stored output from the most recent n iterations, where n can be any integer (with an example being between 1 and 5, or 1 and 10). Criteria can be used to filter the stored output and to select the most appropriate portion of the stored set. Using a later calculated portion of the stored data points of block 110 may be advantageous since later calculated points are presumably of a higher quality as the method 100 iterations result in converging solutions.

The result of the fitting step of block 122 is that the fitness surrogate model has been fitted and is available for use in evaluation in subsequent iterations in block 110. In this manner, a fitness surrogate model is developed that can provide a reasonably accurate estimate of fitness at significantly reduced computational expense as compared to use of the fitness calculator. Use of the fitness surrogate model can greatly speed the evaluation, particularly when the population size of solutions to evaluate is quite large.

As discussed below, in fact, use of the fitness surrogate in embodiments of the invention has been discovered to lead to overall speed-ups of 5 times, 10 times, and even 50 times over use with the expensive fitness calculator alone. Higher speed-ups are believed to be achievable. The particular speed-ups achieved depend on many factors, including but not limited to the complexity of the problem at hand and therefore of the fitness calculator, the size of the population, and others. It is believed that increasing speed-ups will be achieved with increasing problem “size”-larger solution sets, greater complexity, larger solutions, greater noise, and the like are some factors that lead to a “larger” problem and hence greater speed-ups using methods of the invention. These and other factors can affect the criteria for using the expensive fitness calculator verses the less expensive fitness surrogate model of block 104.

Referring once again to FIG. 1 and to the step of model building of block 116, a step of generating new solutions is subsequently performed in block 124. The new solutions may collectively be thought of as a new solution set. There are a variety of particular steps suitable for accomplishing this. For example, a model may be used to generate new solutions. The model may be a different model than the model built in block 124. It may be any of a variety of models, for example, that use the desirable solutions selected in block 114 to predict other desirable solutions. Probabilistic models, predictive models, genetic and evolutionary algorithms, probabilistic model building genetic algorithms (also known as estimation of distribution algorithms), Nelder-Mead simplex method, tabu search, simulated annealing, Fletcher-Powell-Reeves method, metaheuristics, ant colony optimization, particle swarm optimization, conjugate direction methods, memetic algorithms, and other local and global optimization algorithms. The step of block 124 may therefore itself include multiple sub-steps of model creation. In this manner, the method of FIG. 1 and other invention embodiments may be “plugged into” other models to provide beneficial speed-up in evaluation.

In other invention embodiments, the step of generating new solutions of block 124 may include sampling the probabilistic or other model built in block 116 to create new solutions. Through sampling, a new solution set is populated using the model built in block 116. Sampling may comprise, for example, creating a new plurality or even multiplicity of solutions according to a probability distribution of a probabilistic model made in block 116. Because the probabilistic or other model built in step 116 was built using promising solutions to predict additional promising solutions, the sampled solutions that make up the second solution set are presumably of a higher quality than the initial solution set.

A step of determining whether completion criteria have been satisfied is then performed. Block 126. This step may include, for example, determining whether some externally provided criteria are satisfied by the new solution set (or by a random or other sampling of the new solution set). By way of some examples, if the problem at hand is the design of a bridge, completion criteria may include a desired bridge weight maximum, a desired minimum stress failure limit, and a maximum deflection. If the problem at hand concerns a financial model for investing funds, the criteria may be measures of rate of return, volatility, risk, and length of investment. If the problem at hand is related to the trajectory of a missile or asteroid, convergence criteria can include one or more final calculated trajectories, velocities, impact locations, and associated margins of error. If the problem at hand is related to optimizing a circuit design, criteria may include maximum impedance, resistance, and delay.

If the criteria have not been satisfied, a step of replacement is performed to replace all or a portion of the first solution set with the new. Block 128. In many methods of the invention, the entire initial solution set is replaced. In other methods, only a portion of the initial set is replaced with the new solutions. Criteria may define what portion is replaced, which criteria may change dynamically with number of iterations, quality of solutions, or other factors. The method then continues for subsequent iterations with the overall quality of the solutions increasing until the completion criteria are satisfied.

It has been discovered that a significant speed-up, and therefore an efficiency enhancement, in methods for optimizing solution sets can be obtained by using fitness estimation models such as the fitness surrogate model of FIG. 1. This has been discovered to most beneficial when the fitness surrogate model automatically and adaptively incorporates the knowledge of regularities of the search problem. This can be accomplished, for example, when the fitness surrogate model incorporates knowledge of the interactions of variables in the probabilistic model through the step of building a structural fitness model (block 120). One class of probabilistic models that automatically identify important regularities in the search problems is probabilistic model building genetic algorithms (PMBGAs). These have been discovered to be of particular utility in methods of the invention.

Example Probabilistic Models

Having now discussed the example invention embodiment of FIG. 1, more detailed discussion of various aspects of this and other illustrative embodiments of the invention are appropriate. This section describes example probabilistic models that are useful in methods of the invention. Useful illustrative models include, but are not limited to, models that utilize so called genetic algorithm steps or evolutionary computing steps. One example is composite probabilistic fitness-estimation model in PMBGAs, as well as methods for building the same. A brief introduction to PMBGAs in general is presented, and the extended compact genetic algorithm (eCGA) and the Bayesian optimization algorithm (BOA) are described in particular as being two example probabilistic models useful for practice of the invention. Details of developing and using an internal fitness surrogate model for estimating the fitness of some offspring in methods of the invention (e.g., steps of blocks 110, 118-122 of FIG. 1) and other steps are discussed.

Probabilistic model building genetic algorithms replace traditional variation operators of genetic and evolutionary algorithms by building a probabilistic model of promising solutions and sampling the model to generate new candidate solutions. A typical PMBGA consists of the following steps:
1. Initialization: The population can be initialized with random individual solution members, pre-selected solution members, or through other methods.
2. Evaluation: The fitness or the quality-measure of the individuals is determined.
3 Selection: Like traditional genetic algorithms, PMBGAs are selectionist schemes, because only a subset of better individuals is permitted to influence the subsequent generation of candidate solutions.

Different selection schemes used elsewhere in genetic and evolutionary algorithms-tournament selection, truncation selection, proportionate selection, etc.-may be adopted for this purpose, but a key idea is that a “survival-of-the-fittest” mechanism is used to bias the generation of new individuals.
4. Probabilistic model estimation: Unlike traditional GAs, however, PMBGAs assume a particular probabilistic model of the data, or a class of allowable models. A class-selection metric and a class-search mechanism are used to search for an optimum probabilistic model that represents the selected individuals.
5. Offspring creation/Sampling: In PMBGAs, new individuals are created by sampling the probabilistic model.
6. Replacement: Many replacement schemes generally used in genetic and evolutionary computation; generational replacement, elitist replacement, niching, etc., can be used in PMBGAs, but the key idea is to replace some or all the parents with some or all the offspring.
7. Repeat steps 2-6 until one or more termination criteria are met. Further explanation of two of the above steps-model building and model sampling-can be useful. The model-building process involves at least three important elements:
   Model Representation: One useful step before building a probabilistic model is determining a representation or methodology to represent the model itself. Various representations such as marginal product models, Bayesian networks, decision graphs, etc. can be used. Preferably, the representation defines a class of probabilistic models that can represent the promising solutions. Model representation can determine to some extent the step of block 118, 120 and 122 of FIG. 1. That is, the form of the surrogate structural model can depend to a large extent on the representation of the probabilistic model.
   Class-Selection Metric: Once the representation of the model is decided on, a measure or metric is needed to distinguish between better model instances from worse ones. The class-selection metric can be used to evaluate alternative probabilistic models (chosen from the admissible class). Generally, any metric which can compare two or more model instances or solutions is useful. Many selection metrics apply a score or relative score to model instances suing some scoring metric. Different metrics such as minimum description length (MDL) metrics and Bayesian metrics are two of several particular examples suitable for use in invention embodiments.
   Class-Search Method: With the model representation and model metric at hand, a means of choosing better (or possibly: best) models from among the allowable subset members is useful. The class-search mechanism uses the class-selection metric to search among the admissible models for an optimum model. Usually, local search methods such as greedy-search heuristics are used. The greedy-search method begins with models at a low level of complexity, and then adds additional complexity when it locally improves the class-selection metric value. This process continues until no further improvement is possible. After the model is built, a population of new candidate solutions can be generated by sampling the probabilistic model (e.g., step of block 124 of FIG. 1).

Below, the implementation of an evaluation-relaxation method of the invention using a fitness surrogate model is described in two illustrative PMBGA's: the extended compact genetic algorithm (eCGA) and the Bayesian optimization algorithm (BOA).

Example Probabalistic Model: eCGA

Steps of model representation, class-selection metric, and class-search method-of extended compact genetic algorithm (eCGA) are outlined in this section.

Model representation in eCGA: Those knowledgeable in the art appreciate that the probability distribution used in eCGA is a class of prob-ability models known as marginal product models (MPM). MPM's partition genes (e.g., individual variables or bit positions) into mutually independent groups. Thus, instead of treating each position independently like PBIL and the compact GA, several genes can be tightly linked in a linkage group. For example, the following MPM, [1,3] [2] [4] for a four-bit problem represents that the 1^{st} and 3^{rd} genes are linked and 2^{nd} and 4^{th} genes are independent. An MPM can also specify probabilities for each linkage group. For the above example, the MPM consists of the marginal probabilities p as follows: { p(x₁=0, X₃=0), p(X₁=0, X₃=1), p(X₁=1, X₃=0), p(X₁=1, X₃=1), p(X₂=0), p(x₂=1), p(x₄=0), p(x₄=1)}, where xᵢ is the value of the i^{th} gene.

Class-Selection metric in eCGA: To distinguish between better model instances from worse ones, eCGA uses a minimum description length (MDL) metric. MDL is known by those skilled in the art. The key concept behind MDL models is that all things being equal, simpler models are better than more complex ones-shorter required description lengths are preferred over longer. The MDL metric used in eCGA is a sum of two components: (1) model complexity, and (2) compressed population complexity.

The model complexity, Cₘ, quantifies the model representation size in terms of number of bits required to store all the marginal probabilities. Let a given problem of size ƒ with binary alphabets have m partitions with kᵢ genes in the i^{th} partition, such that Σᵢ^{m}=¹kᵢ=l. Then each partition i requires 2^{k}−1 independent frequencies to completely define its marginal distribution. Furthermore, each frequency can be represented by log₂(n) bits, where n is the population size. Therefore, the model complexity Cₘ, is given by:

$${C}_{m} = {log}_{2} ( n ) {\sum }_{i = 1}^{m} ( {2}^{{k}_{i}} - 1 ) \qquad Eq . 1 ( a )$$

The compressed population complexity, Cₚ, quantifies the data compression in terms of the entropy of the marginal distribution over all partitions. Therefore, Cₚ is evaluated as

$${C}_{P} = n {\sum }_{i = 1}^{m} {\sum }_{j = 1}^{{2}^{{k}_{i}}} - {p}_{ij} {log}_{2} ( {p}_{ij} ) , \qquad Eq . 1 ( b )$$

where pᵢⱼ is the frequency of the j^{th} gene sequence of the genes belonging to the i^{th} partition. In other words, pᵢⱼ=Nᵢⱼ/n, where Nᵢⱼ is the number of chromosomes in the population (after selection) possessing bit-sequence j∈└1,2^{k}_{ⁱ}┘ for i^{th} partition.

Class-Search method in eCGA: In eCGA, both the structure and the parameters of the model are searched and optimized to best fit the data. While the probabilities are learned based on the variable instantiations in the population of selected individuals, a greedy search heuristic can be used to find an optimal or near-optimal probabilistic model. The search method starts by treating each decision variable as independent. The probabilistic model in this case is a vector of probabilities, representing the proportion of individuals among the selected individuals having a value ‘1’ (or alternatively ‘0’) for each variable. The model-search method continues by merging two partitions that yields greatest improvement in the model-metric score. The subset merges are continued until no more improvement in the metric value is possible.

The offspring population is generated by randomly generating subsets from the current individuals according to the probabilities of the subsets as calculated in the probabilistic model.

Example Probabilistic Model: Bayesian Optimization Algorithm (BOA)

The Bayesian optimization algorithm (BOA) is generally known, and detailed description herein is therefore not necessary. A few general concepts are provided, however, by way of a detailed description of steps of illustrative invention embodiments. The model representation, class-selection metric and class search method used in the BOA are outlined below by way of background and of detailing how BOA may be utilized in methods of the invention.

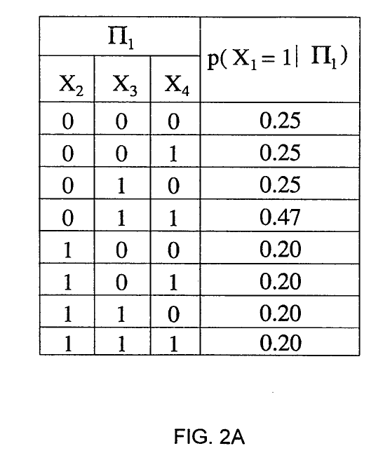

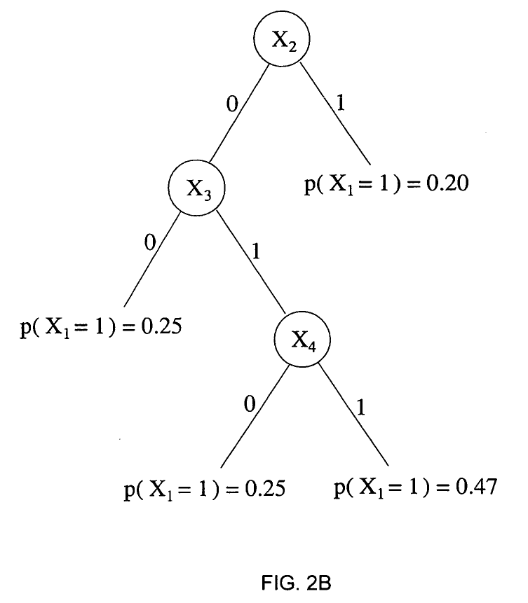

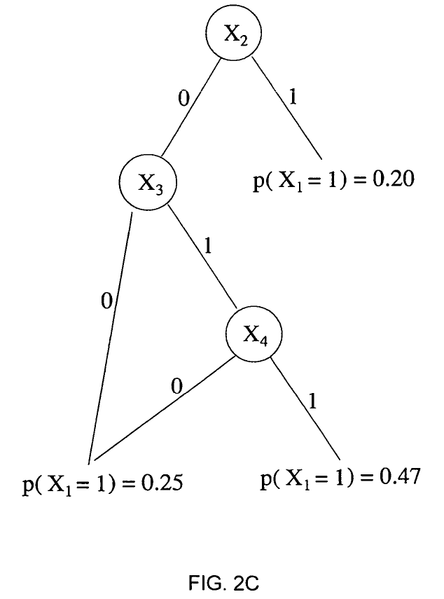

FIG. 2 is a representative conditional probability table for p(X₁|X₂,X₃,X₄) using traditional representation (a) as well as local structures (b and c).

Model representation in BOA: BOA uses Bayesian networks to model candidate solutions. Bayesian networks (BNs) are popular graphical models, where statistics, modularity, and graph theory are combined in a practical tool for estimating probability distributions and inference. A Bayesian network is defined by two components: (1) structure, and (2) parameters.

The structure is encoded by a directed acyclic graph with the nodes corresponding to the variables in the modeled data set (in this case, to the positions in solution strings) and the edges corresponding to conditional dependencies. A Bayesian network encodes a joint probability distribution given by

$$p ( X ) = {\prod }_{i = 1}^{n} p \text{(} {X}_{i} \vert {\prod }_{i}^{} ) \qquad Eq . 2$$

where x=(x₀, . . . , xₙ₋ᵣ) is a vector of all the variables in the problem; Πᵢ is the set of parents of Xᵢ(the set of nodes from which there exists an edge to Xᵢ); and p(X₁|Πᵢ) is the conditional probability of Xᵢgiven its parents Πᵢ.

A directed edge (illustrated as a line connecting nodes) relates the variables so that in the encoded distribution the variable corresponding to the terminal node is conditioned on the variable corresponding to the initial node. More incoming edges into a node result in a conditional probability of the variable with a condition containing all its parents. In addition to encoding dependencies, each Bayesian network encodes a set of independence assumptions. Independence assumptions state that each variable is independent of any of its antecedents in the ancestral ordering, given the values of the variable's parents.

The parameters are represented by a set of conditional probability tables (CPTs) specifying a conditional probability for each variable given any instance of the variables that the variable depends on. Local structures-in the form of decision trees or decision graphs can also be used in place of full conditional probability tables to enable more efficient representation of local conditional probability distributions in Bayesian networks.

Conditional probability tables (CPT's): Conditional probability tables store conditional probabilities p(xᵢ|Πᵢ) for each variable xᵢ. The number of conditional probabilities for a variable that is conditioned on k parents grows exponentially with k. For binary variables, for instance, the number of conditional probabilities is 2^{k}, because there are 2^{k} instances of k parents and it is sufficient to store the probability of the variable being 1 for each such instance. FIG. 2(a) shows an example CPT for p(x₁|x₂,x₃,x₄). Nonetheless, the dependencies sometimes also contain regularities. Furthermore, the exponential growth of full CPTs often obstructs the creation of models that are both accurate and efficient. That is why Bayesian networks are often extended with local structures that allow more efficient representation of local conditional probability distributions than full CPTs.

Decision trees for conditional probabilities: Decision trees are among the most flexible and efficient local structures, where conditional probabilities of each variable are stored in one decision tree. Each internal (non-leaf) node in the decision tree for p(xᵢ|Πⱼ) has a variable from Πᵢ associated with it, and the edges connecting the node to its children stand for different values of the variable. For binary variables, there are two edges coming out of each internal node: one edge corresponds to 0, and the other corresponds to 1. For more than two values, either one edge can be used for each value, or the values may be classified into several categories and each category would create an edge.

Each path in the decision tree for p(xᵢ|Πᵢ) that starts in the root of the tree and ends in a leaf encodes a set of constraints on the values of variables in Πᵢ. Each leaf stores the value of a conditional probability of xᵢ=1 given the condition specified by the path from the root of the tree to the leaf. A decision tree can encode the full conditional probability table for a variable with k parents if it splits to 2^{k} leaves, each corresponding to a unique condition. However, a decision tree enables more efficient and flexible representation of local conditional distributions. See FIG. 2(a) for an example decision tree for the conditional probability table presented earlier.

Class-selection metric in BOA: Network quality can be measured by any popular scoring metric for Bayesian networks, such as the Bayesian Dirichlet metric with likelihood equivalence (BDe) or the Bayesian information criterion (BIC). In the current example invention embodiment, we use a combination of the BDe and BIC metrics, where the BDe score is penalized with the number of bits required to encode parameters.

Class-search method in BOA: To learn Bayesian networks, a greedy algorithm can be used for its efficiency and robustness. The greedy algorithm starts with an empty Bayesian network. Each iteration then adds an edge into the network that improves quality of the network the most. The learning is terminated when no more improvement is possible.

To learn Bayesian networks with decision trees, a decision tree for each variable xᵢ is initialized to an empty tree with a univariate probability of xᵢ=1. In each iteration, each leaf of each decision tree is split to determine how quality of the current network improves by executing the split and the best split is performed. The learning is finished when no splits improve the current network anymore.

Building an Example Surrogate Fitness Model Using a Probabilistic Model

The previous section outlined example probabilistic model building genetic algorithms in general, and eCGA and the BOA in particular. This section describes illustrative steps of building a fitness surrogate model using a probabilistic model, and then performing evaluation with that fitness surrogate model (e.g., steps of blocks 118, 110 of FIG. 1). That is, this section describes how a surrogate fitness model can be built and updated in PMBGAs, and how new candidate solutions can be evaluated using the model. The methodology is illustrated with MPM's in eCGA, Bayesian networks with full CPTs as well as the ones with local structures in BOA. The section also details where the statistics can be acquired from to build an accurate fitness model. From the example steps presented and discussed in this section, other steps useful for accomplishing the same in other probabilistic models will be appreciated.

Building Example Fitness Surrogate Model Using Polynomial/Least Squares Fit

As illustrated above with respect to FIG. 1, the model built in block 116 may take any of a variety of particular forms. Some useful models will include variables, some of which interact with one another. For example, many PMBGA's can be expressed in a form that includes variables at least some of which interact with others. In these embodiments, the step of block 120 may include inferring or otherwise extracting knowledge of the interaction of variables to create a structural model. The structural model may be expressed in the form of a polynomial or other equation that includes coefficients. The structural model may be, for example, a cubic or quadratic polynomial equation with multiple unknown constant coefficients.

In these embodiments, the step of block 122 can include solving for the coefficient constants through curve fitting, linear regression, or other like procedures. It has been discovered that performing steps of creating the structural model (block 120) in a form that includes coefficients, and then fitting those coefficients through a least squares fit (block 122) are convenient and accurate steps for creating a surrogate fitness model (block 118).

Other steps of curve fitting in addition to performing a least squares fit may likewise be performed. For example, an additional step believed to be useful is to perform a recursive least squares fit. A step of performing a recursive least squares fit will provide the benefit of avoiding creating the model from the “ground up” on every iteration. Instead, a previously created model can be modified by considering only the most recently generated expensive data points from the database 112. In many applications, this may provide significant benefits and advantages.

Building Example Fitness Surrogate Model Using MPMs/eCGA

In addition to building a model through use of a polynomial and performing a least squares fit calibration, other steps may be performed. For example, in eCGA, a step of estimating the marginal fitness of all schemas represented by the MPM can be performed. In all, the fitness of a total of Σᵢ₌₁^{m}2^{k}_{ⁱ} schemas is estimated. Considering the previous example presented above of a four-bit problem whose model is [1, 3] [2] [4], the schemata whose fitnesses are estimated are: {0*0*, 0*1*, 1*0*, 1*1*, *0**, *1**, ***0, ***1}.

The fitness of a schema, h, can be defined as the difference between the average fitness of individuals that contain the schema and the average fitness of all the individuals. That is,

$${\hat{f}}_{s} ( h ) = \frac{1}{{n}_{h}} {\sum }_{\{ i \vert {x}_{i} ⊃ h \}} f ( {x}_{i} ) - \overline{f} ( H ) ;$$

$$\overline{f} ( h ) = \frac{1}{{n}_{h}} {\sum }_{\{ i \vert {x}_{i} ⊃ h \}} f ( {x}_{i} ) - \overline{f} ( H )$$

where n^{h} is the total number of individuals that contain the schema hᵢ, xᵢ is the i^{th} individual and ƒ(xᵢ) is its fitness, \overline{ƒ}(H) is the average fitness of all the schemas in the given partition. If a particular schema is not present in the population, its fitness is set to zero. Furthermore, it should be noted that the above definition of schema fitness is not unique and many other suitable estimates and steps can be used. A useful benefit can be gained, however, by the use of the probabilistic model in determining the schema fitnesses.

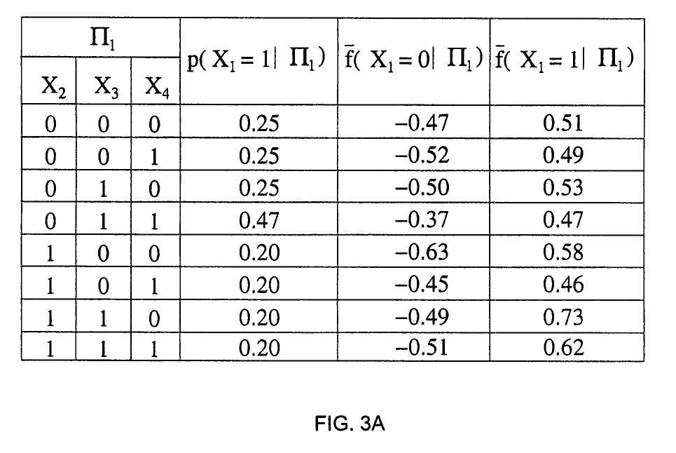

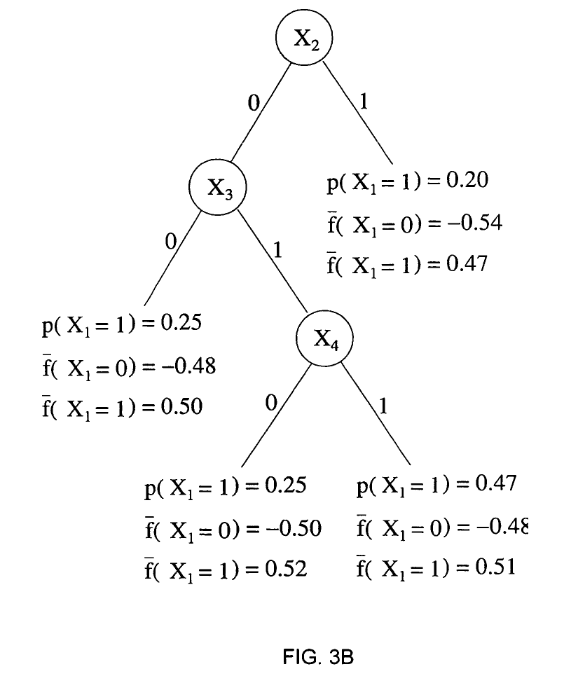

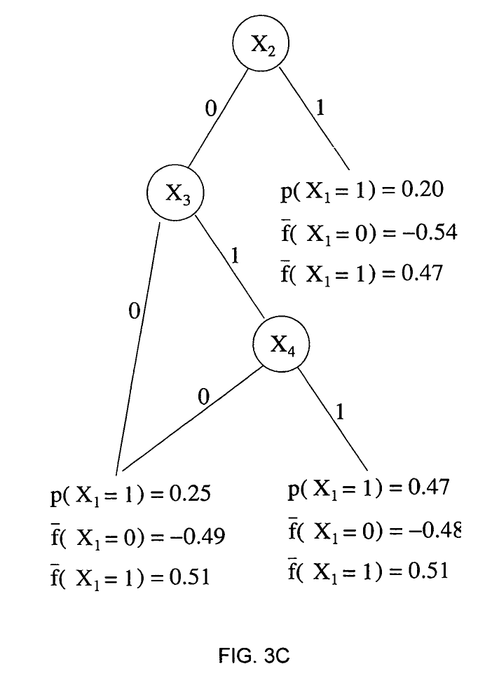

Once the schema fitnesses across partitions are estimated, the offspring population is created as outlined above (“eCGA” section). An offspring is evaluated using the fitness surrogate with a probability pᵢ, referred to as the inheritance probability. This can be computed as follows:

$$fest ( y ) = \overline{f} + {\sum }_{i = 1}^{m} {\hat{f}}_{s} ( {h}_{i} ∈ y ) , \qquad Eq . 3$$

where y is an offspring individual, and \overline{71} is the average fitness of the solutions used to build the fitness model. FIG. 3 illustrates fitness inheritance in a conditional probability table for p(X₁|X₂, X₃, X₄) (a) and its representation using local structures (FIG. 3(b) and (c)).
Building Example Fitness Surrogate Model Using CPTs in BOA

In BOA, for every variable Xᵢ and each possible value xᵢ of Xᵢ, an average fitness of solutions with Xᵢ=Xᵢ must be stored for each instance ¶ᵢ of Xᵢś parent Πᵢ. In the binary case, each row in the conditional probability table is thus extended by two additional entries. FIG. 3(a) shows an example conditional probability table extended with fitness information based on the conditional probability table presented in FIG. 2(a). The fitness can then be estimated as

$${f}_{est} ( {X}_{1} , {X}_{2} , … {X}_{n} ) = \overline{f} + {\sum }_{i = 1}^{n} ( \overline{f} \text{(} {X}_{i} \vert {\prod }_{i}^{} ) - \overline{f} ( {X}_{i} ) ) , \qquad Eq . 4$$

where (\overline{ƒ}(Xᵢ|Πᵢ) denotes the average fitness of solutions with Xᵢ and Π_{I}, and \overline{ƒ}(Πᵢ) is the average fitness of all solutions with Πᵢ. Then:

$$\overline{f} ( {\prod }_{i}^{} ) = {\sum }_{{X}_{i}} p \text{(} {X}_{i} \vert {\prod }_{i}^{} ) \overline{f} \text{(} {X}_{i} \vert {\prod }_{i}^{} ) . \qquad Eq . 5$$

Building Example Surrogate Fitness Model Using Decision Graphs in BOA

Many other method steps are suitable for building a fitness surrogate model in BOA. For example, similar method steps as for full CPT's can be used to incorporate fitness information into Bayesian networks with decision trees or graphs. The average fitness of each instance of each variable must be stored in every leaf of a decision tree or graph. FIGS. 3(b) and (c) show examples of decision tree and graph extended with fitness information based on the decision tree and graph presented in FIGS. 2(b) and 2(c), respectively. The fitness averages in each leaf are restricted to solutions that satisfy the condition specified by the path from the root of the tree to the leaf.

Evaluation

In an example method of the invention, a first step of fully evaluating the initial population is performed, and thereafter evaluating an offspring with a probability (1-pⁱ). In other words, this example invention embodiment applies a criteria of using the probabilistic fitness surrogate model to estimate the fitness of an offspring with probability pᵢ. In the below section, an example source for obtaining information for computing the statistics for the fitness surrogate model is discussed (e.g., step of coefficient fitting of block 122 of FIG.1).

Estimating the Marginal Fitnesses

In the illustrative method, for each instance xᵢ of Xᵢ, and each instance πᵢ of Xᵢ's parent Πᵢ, we can compute the average fitness of all solutions with Xᵢ=xᵢ and Π_{I}=πᵢ. Similarly, in eCGA the schema fitness \hat{ƒ}ₛ(h) should be computed as well as the average partition fitness \overline{ƒ}(H). This section discusses two sources for computing the above fitness surrogate model statistics:
1. Selected parents that were evaluated using the actual fitness function (e.g., output stored in database shown as block 112 of FIG. 1 from first iteration on initial solution set), and/or
2. The offspring that were evaluated using the actual fitness function. (e.g., output stored in database shown as block 112 of FIG. 1 from second and subsequent iterations)
   Other sources are also suitable. For example, a step of coefficient fitting for the surrogate model can be performed using the output from one or more previous iteration(s), regardless of whether the output was generated using the fitness calculator or the fitness surrogate model.

One reason for restricting computation of fitness-inheritance statistics to selected parents and offspring is that the probabilistic model used as the basis for selecting relevant statistics represents nonlinearities in the population of parents and the population of offspring. Since it is preferred to maximize learning data available, it is preferred to use both populations to compute the fitness inheritance statistics. The reason for restricting input for computing these statistics to solutions that were evaluated using the actual fitness function is that the fitness of other solutions was estimated only and it involves errors that could mislead fitness inheritance and propagate through generations.

Example Empirical Test Results

This section starts with a brief description and motivation of the test problems used for verifying the illustrative methods and demonstrating the utility of a proposed method for optimizing a solution set using a fitness surrogate evaluator. The analysis then empirically verifies the convergence-time and population-sizing models developed above. Finally, empirical results are presented for the scalability and the speed-up provided by using a fitness surrogate model to estimate fitness of some offspring and some important results are discussed.

Test Functions

This section briefly describes the two test functions that were used to verify illustrative methods and to obtain empirical results with these illustrative methods. The approach in verifying the methods and observing if fitness inheritance yields speed-up was to consider bounding adversarial problems that exploit one or more dimensions of problem difficulty. Of particular interest are problems where building-block identification is critical for the GA success. Additionally, the problem solver (e.g., eCGA and BOA) should not have any knowledge of the BB structure of the problem.

Many different test functions are available for verifying and testing results of illustrative methods of the invention. Two test functions with the above properties that were used in this study are:

1. The OneMax problem, which is well-known to those skilled in the art and is a GA-friendly easy problem in which each variable is independent of the others. OneMax is a linear function that computes the sum of bits in the input binary string:

$${f}_{OneMax} ( {X}_{1} , {X}_{2} , … , {X}_{l} ) = {\sum }_{i = 1}^{n} {X}_{i} , \qquad Eq . 6$$

where (X₁, X₂, . . . , Xₗ) denotes the input binary string of l bits. For the OneMax problem, the true BB fitness is the fitness contribution of each bit. For an ideal probabilistic fitness model developed for the OneMax problem, the average fitness of a 1 in any partition (or leaf in the case of BOA) should be approximately 0.5, whereas the average fitness of a 0 in any partition (or leaf) should be approximately −0.5. As a result, solutions will get penalized for 0s, while they would be rewarded for 1's. The average fitness will vary throughout the run. The present embodiment considers OneMax of length (e)=50, 100, and 200 bits.

While the optimization of the OneMax problem is straightforward, the probabilistic models built by eCGA (or BOA, other PMBGA's, or other models) for OneMax, however, are known to be only partially correct and include spurious linkages. Therefore, the inheritance results on the OneMax problem will indicate if the effect of using partially correct linkage mapping on the inherited fitness is significant. A 100-bit OneMax problem is used to verify convergence-time and population-sizing steps.

2. The second test function used is the “m-k Deceptive trap problem,” which is known to those knowledgeable in the art and need not be detailed at length herein. By way of brief description, the m-k Deceptive trap problem consists of additively separable “deceptive” functions. Deceptive functions are designed to thwart the very mechanism of selectorecombinative search by punishing and localized hill climbing and requiring mixing of whole building blocks at or above the order of deception. Using such adversarially designed functions is a stiff test of method performance. The general idea is that if a method of the invention can beat such as stiff test function, it can solve other problems that are equally hard (or easier) than the adversary.

In m concatenated k-bit traps, the input string is first partitioned into independent groups of k bits each. This partitioning should be unknown to the method, but it should not change during the run. A k-bit trap function is applied to each group of k bits and the contributions of all traps are added together to form the fitness. Each k-bit trap is defined as follows:

$$if u = k , \\ {trap}_{k} ( u ) = \{ \begin{matrix} 1 \\ ( 1 - d ) [ 1 - \frac{u}{k - 1} ]\end{matrix} otherwise \qquad Eq . 7$$

where u is the number of 1's in the input string of k bits and d is the signal difference between the best sub solution and its deceptive attractor. An important feature of traps is that in each of the k-bit traps, all k bits must be treated together, because all statistics of lower order lead the function away from the optimum. That is why most crossover operators will fail at solving this problem faster than in exponential number of evaluations, which is just as bad as blind search.

Unlike in OneMax, \overline{ƒ}(Xᵢ=0) and \overline{ƒ}(Xᵢ=1) depend on the state of the search because the distribution of contexts of each bit changes over time and bits in a trap are not independent. The context of each partition (leaf) also determines whether \overline{ƒ}(Xᵢ=0)<\overline{ƒ}(Xᵢ=1) or \overline{ƒ}(Xᵢ=0)>\overline{ƒ}(Xᵢ=1) in that particular partition (leaf). This example considers m=10, and 20, k=4 and 5, and d=0.25 and 0.20.

Model Verification

This section presents empirical results for verifying and supporting empirical results. Before presenting empirical results, the population-size-ratio and the convergence-time-ratio models user are provided (Eqs. 8 and 9, respectively):

$$\begin{matrix}{n}_{r} = \frac{n}{{n}_{o}} = ( 1 + {p}_{i} ) . & Eq . 8 \\ {t}_{c , r} = \frac{{t}_{c}}{{t}_{c , o}} = \sqrt{1 + {p}_{i} .} & Eq . 9\end{matrix}$$

The above convergence-time and population-sizing models were verified by building and using a fitness model in eCGA. A tournament selection with tournament sizes of 4 and 8 was used in obtaining the empirical results. An eCGA run is terminated when all the individuals in the population converge to the same fitness value. The average number of variable building blocks correctly converged are computed over 30-100 independent runs, where the term “variable building block” is intended to be broadly interpreted as a group of related variables. A variable building block will be referred to herein as a “BB” for convenience. The minimum population size required such that m-l BB's converge to the correct value is determined by a bisection method. The results of population size and convergence-time ratio are averaged over 30 such bisection runs (which yields a total of 900-3000 independent successful eCGA runs).

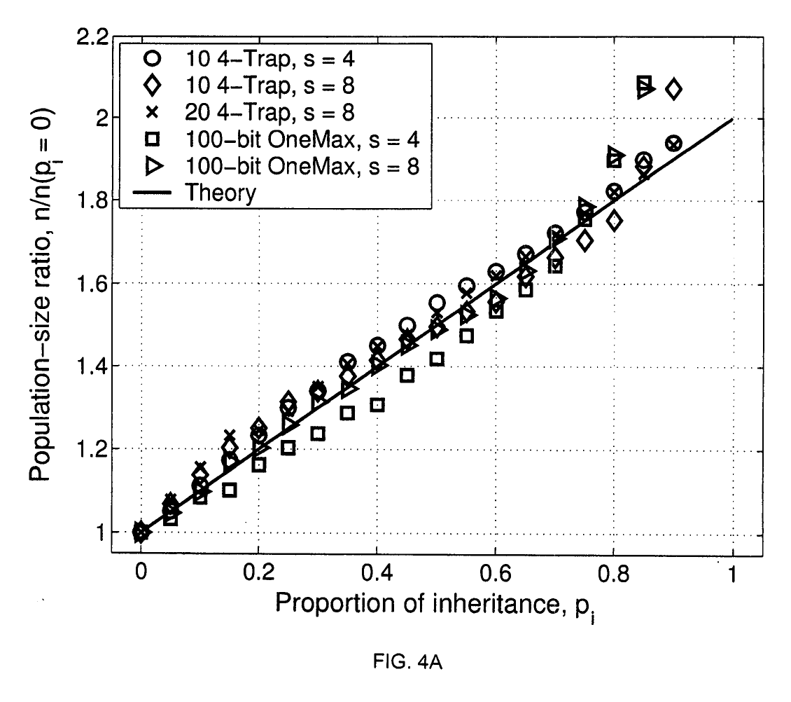

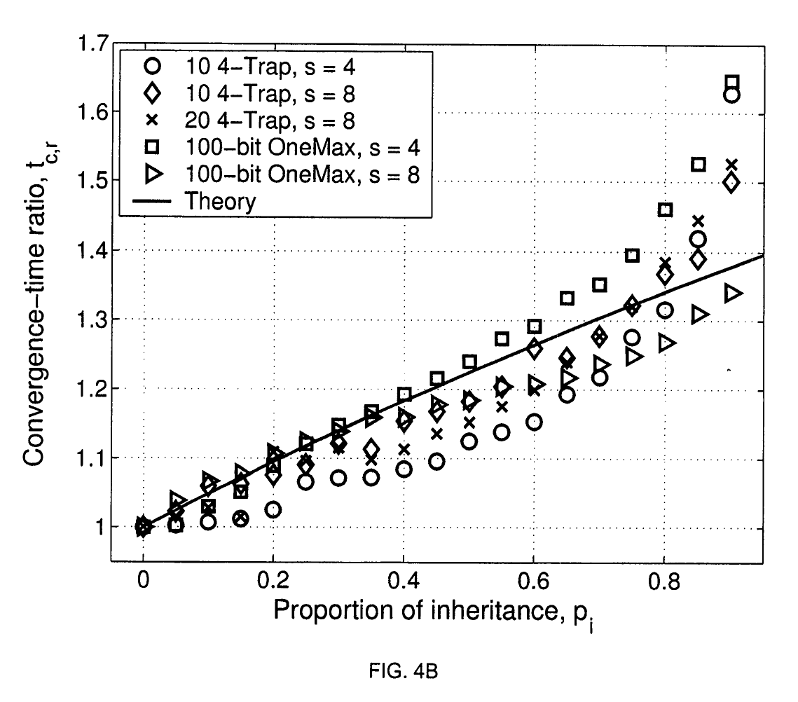

FIG. 4 illustrates a verification of the population-size-ratio model (Eq. 8) and convergence-time-ratio model (Eq. 9) for various values of pᵢ with empirical results for 100-bit OneMax and 104-Trap problems. The population size is determined by a bisection method such that the failure probability averaged over 30-100 independent runs is 1/m (that is, α=1/m). The convergence time is determined by the number of generations required to achieve convergence on m-1 out of m BB's correctly. The results are averaged over 30 independent bisection runs.

The population-size-ratio model (Eq. 8) is verified with empirical results for OneMax and m-k Trap in FIG. 4(a). The standard deviation for the empirical runs are very small (σ∈|4 ×10⁻⁴, 1.8×10^{-2|}), and therefore the error bars are not shown in FIG. 4(a). As shown in the figure, the empirical results agree with the model. The population size required to ensure that, on an average, eCGA fails to converge on at most one out of m BB's, increases linearly with the inheritance probability, pᵢ. The population sizes required at very high inheritance-probability values, pᵢ≧0.85, deviate from the predicted values. This is because the noise introduced due to inheritance increases significantly at higher Pᵢ values because of limited number of individuals with evaluated fitness (e.g., fitness calculated using calculator of block 108 of FIG. 1) that take part in the estimate of schemata fitnesses.

The verification of the convergence-time-ratio model (Eq. 9) with empirical results for OneMax and m k-Trap are shown in FIG. 4(b). The standard deviations for the empirical runs are very small (σ∈12×10⁻⁴, 2.7×10^{-2|}), and therefore the error bars are not shown. As shown in the figure, the agreement between the empirical results and the model is slightly poor when compared to that for population-size ratio. This is because of the approximations used in deriving the convergence time model. More accurate, but complex, models exist that improve the predictions. However, as shown below, any disagreement between the model and experiments does not significantly affect the prediction of speed-up, which is the key objective.

The empirical convergence-time ratio deviates from the predicted value at slightly lower inheritance probabilities, pᵢ≧0.75, than the population-size ratio. This is to be expected as the population sizing is largely dictated by the fitness and noise variances in the initial few generations, while the convergence time is dictated by the fitness and noise variances over the GA run. Therefore, the effect of high Pᵢ values, or fewer evaluated individuals, is cumulative over time and leads to deviation from theory at lower pᵢ values than the population size.

Scalability and Speed-Up Results

The previous section verified illustrative convergence-time and population-sizing models. This section presents scalability and speed-up results obtained by the illustrative proposed fitness surrogate method when using both eCGA and BOA. Using the convergence-time and population-sizing models, models for predicting the effect of using a surrogate fitness model on the scalability and speedup were developed as:

$$\begin{matrix}{n}_{fe , r} = {( 1 + {p}_{i} )}^{1.5} ( 1 - {p}_{i} ) + \frac{{p}_{i} ( 1 + {p}_{i} )}{{t}_{c} ( {p}_{i} = 0 )} \approx {( 1 + {p}_{i} )}^{1.5} ( 1 - {p}_{i} ) , & Eq . 10 \\ {η}_{endogenous fitness model} \approx \frac{1}{{( 1 + {p}_{i} )}^{1.5} ( 1 - {p}_{i} )} . & Eq . 11\end{matrix}$$

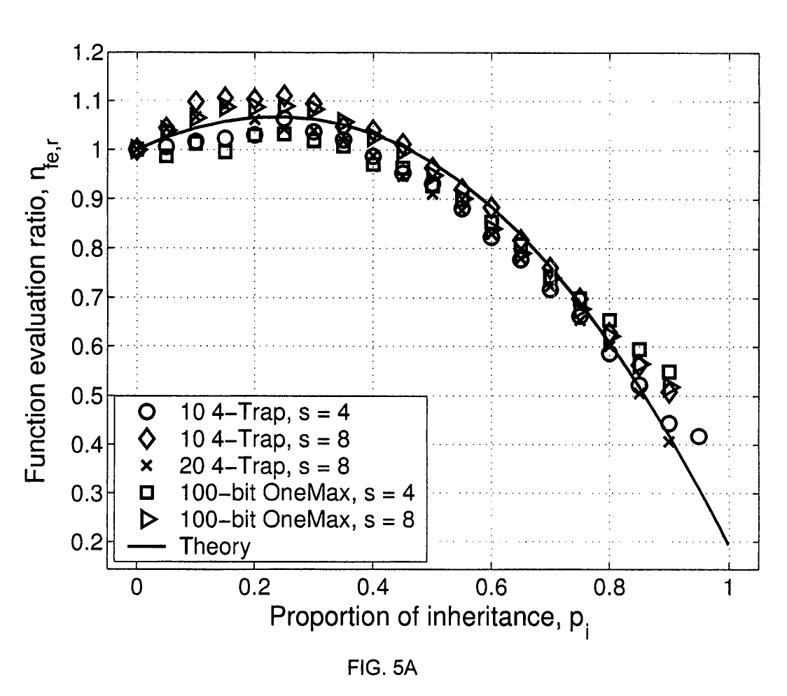

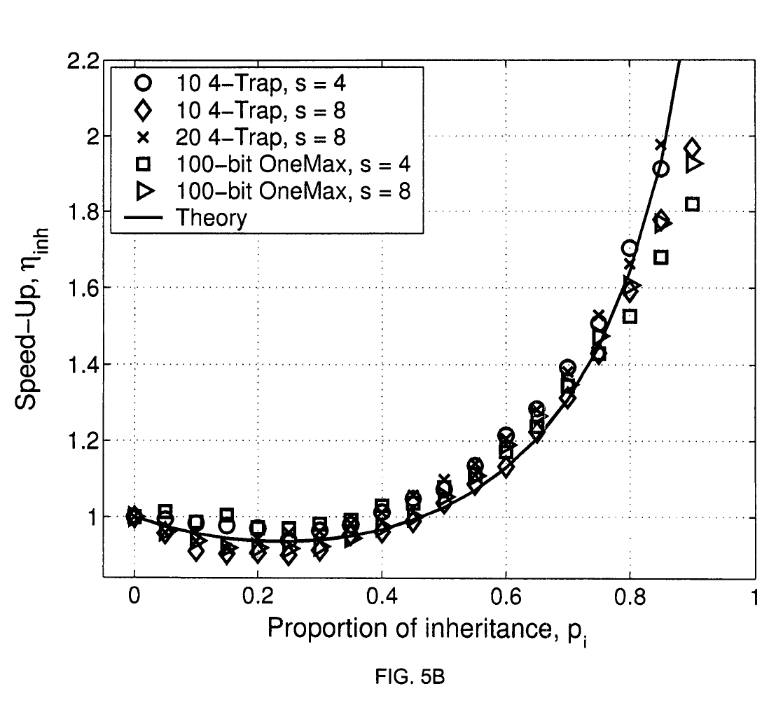

FIG. 5 illustrates the effect of using a fitness surrogate model on the total number of function evaluations required for eCGA success (Eq. 10), and the speed-up obtained by using a fitness surrogate model according to an example method of the invention using eCGA (Eq. 18) for 100-bit OneMax, 10 4-Trap, and 20 4-Trap problems. The total number of function evaluations is determined such that the failure probability of an eCGA run is at most 1/m. The results are averaged over 900-3000 independent runs.

FIGS. 5(a) and (b) therefore present scalability and speed-up results for eCGA on a 100-bit OneMax, 10 4-Trap, and 20 4-rap functions at two different tournament size values, S=4 and 8. An eCGA run is terminated when all the individuals in the population converge to the same fitness value. The average number of BB's correctly converged are computed over 30-100 independent runs. The minimum population size required such that m-1 BB's converge to the correct value is determined by a bisection method. The standard deviation for the empirical runs is very small (σ∈└7×10⁻⁵, 7×10⁻³┘, and therefore are not shown.

As predicted by Eq. 10, empirical results for the illustrative method embodiment being tested indicate that the function-evaluation ratio increases (or the speed-up reduces) at low pᵢ values, reaches a maximum at about pᵢ=0.2. When pᵢ=0.2 the number of function evaluations required is 5% more than that required when the fitness model is not used. In other words, the speed-up at p_{i=0.2} is about 0.95. For pᵢ>0.2 the function-evaluation ratio decreases (speed-up increases) with pᵢ. Eq. 11 predicts that the speed-up is maximum when pᵢ=1.0, however, empirical testing for the illustrative method embodiment indicated that the fitness and linkage-map models developed in eCGA are not entirely valid for higher pᵢ values (pᵢ≧0.9). Therefore, in the illustrative method embodiment using eCGA the optimal (or practical) probability of estimating fitness was found to be about 0.9 (that is, about pᵢ=0.9) and the speed-up obtained is about 1.8-2.25. That being said, global solution is still obtained even when pᵢ=1.0 (all offspring fitness values are estimated using fitness surrogate model). However, the number of function evaluations required was four times greater than that required without inheritance.

Additionally, the agreement for the OneMax problem with the models is good even though the linkage-map identification and subsequently the fitness model for the OneMax problem is only partially correct. The results show that the required number of function evaluations is almost halved with the use of a fitness surrogate model thereby leading to a speed-up of 1.8-2.25. This is a significant improvement over the prior art. Furthermore, the illustrative method of the invention using a fitness surrogate model yields speed-up even for high pᵢ values (as high as 0.95).

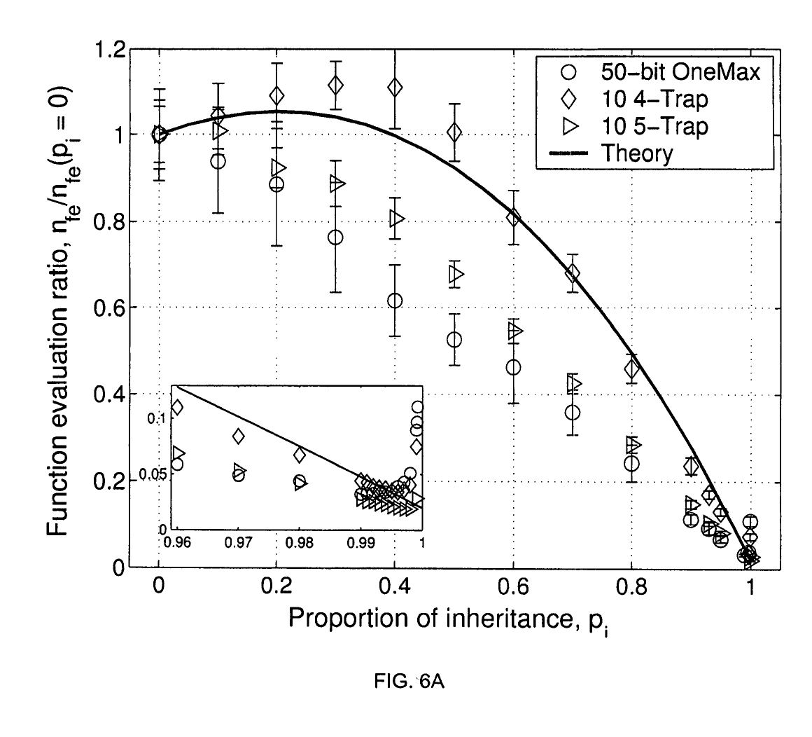

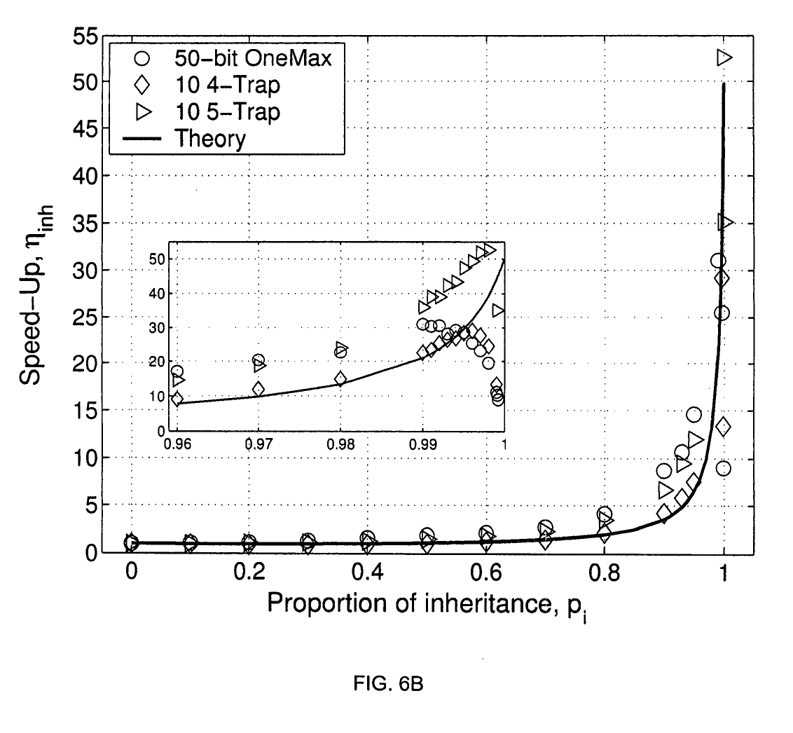

FIG. 6 illustrates the effect of an illustrative step of using a fitness surrogate model on the total number of function evaluations required for BOA success, and the speed-up obtained by using the surrogate fitness method with BOA. The empirical results are obtained for a 50-bit OneMax, 104-Trap and 105-trap problems.

FIGS. 6(a) and 6(b) present the scalability and speed-up results for BOA on a 50-bit OneMax, 104-Trap, and 105-Trap functions. A binary (8=2) tournament selection method was considered without replacement. On each test problem, the following fitness inheritance proportions were considered: 0 to 0.9 with step 0.1, 0.91 to 0.99 with step 0.01, and 0.991 to 0.999 with step 0.001. For each test problem and pᵢ value, 30 independent experiments were performed. Each experiment consisted of 10 independent runs with the minimum population size to ensure convergence to a solution within 10% of the optimum (i.e., with at least 90% correct bits) in all 10 runs. For each experiment, bisection method was used to determine the minimum population size and the number of evaluations (excluding the evaluations done using the model of fitness) was recorded. The average of 10 runs in all experiments was then computed and displayed as a function of the proportion of candidate solutions for which fitness was estimated using the fitness model. Therefore, each point in FIGS. 6(a) and 6(b) represents an average of 300 BOA runs that found a solution that is at most 10% from the optimum.

Similar to eCGA results and as predicted by the facetwise models, in all experiments, the number of actual fitness evaluations decreases with pᵢ. Unlike eCGA, however, the surrogate fitness models built in BOA are applicable at high pᵢ values, even as high as 0.99. Therefore, in this illustrative method we obtain significantly higher speed-up with BOA than with eCGA. That is, by evaluating less than 1% of candidate solutions using an expensive fitness calculator (e.g., block 108 of FIG. 1) and estimating the fitness for the rest using the surrogate fitness model (e.g., block 110 of FIG. 1), speed-ups of 31 (for OneMax) and 53 (for m-kTrap) are obtained. In other words, an example method of the invention that uses a fitness surrogate model to estimate the fitness of 99% of the individuals can reduce the actual fitness evaluation required to obtain high quality solutions by a factor of up to 53. This represents a valuable and beneficial improvement over the prior art. which can lead to significant cost savings and other benefits.

Overall, the results confirm that significant efficiency enhancement can be achieved through methods, program products and systems of the invention that utilize a fitness surrogate model that incorporates knowledge of important sub-solutions or variable interaction of a problem and their partial fitnesses. The results clearly indicate that using the fitness model in eCCA and BOA, by way of particular example, can reduce the number of solutions that must be evaluated using the actual fitness function by a factor of 2 to 53 for the example problems and methods considered. Other speed-ups are expected for other methods and problems, with even greater degree of speed-up expected in some applications.

Consequently, when fitness evaluation provides a bottleneck on processing, methods of the invention can provide important benefits and advantages. For real-world problems, the actual savings may depend on the problem considered. However, it is expected that developing and using the fitness-surrogate models enables significant reduction of fitness evaluations on many problems because deceptive problems of bounded difficulty bound a large class of important nearly decomposable problems.

Discussion and details of example embodiments and steps of the invention have been provided herein. It will be appreciated that the present invention is not limited to these example embodiments and steps, however. Many equivalent and otherwise suitable steps and applications for methods of the invention will be apparent to those knowledgeable in the art. By way of example, invention embodiments have been discussed herein with respect to optimizing solution sets. It will be appreciated that solution sets may be related to a wide variety of real world problems. Examples include solutions to engineering problems (e.g., design of a bridge or other civil engineering project, design of a chemical formulation process or other chemistry related project, design of a circuit or other electrical engineering related problem, trajectory of a missile or other object, etc.), financial problems (e.g., optimal distribution of funds or loans), and the like. Additionally, although the example method of FIG. 1 has been shown as occurring in a particular sequence of steps, the invention is not limited to this sequence, and particular steps may be performed in other sequences. Also, it will be appreciated that some steps may be omitted, and other steps may be added within the scope of the invention as claimed.

What is claimed is:

1. A method for optimizing a solution set comprising the steps of, not necessarily in the sequence listed:
a) creating an initial solution set;
b) identifying a desirable portion of said initial solution set using a fitness calculator;
c) creating a model that is representative of said desirable portion;
d) using said model to create a surrogate fitness estimator that is computationally less expensive than said fitness calculator;
e) generating new solutions;
f) replacing at least a portion of said initial solution set with said new solutions to create a new solution set; and
g) evaluating at least a portion of said new solution set with said fitness surrogate estimator to identify a new desirable portion.

2. A method for optimizing a solution set as defined by claim 1 and further including the step of determining whether completion criteria are satisfied and if not repeating steps c)-g) until said completion criteria are completed, said step of repeating including replacing said desirable portion in step c) with said new desirable portion and replacing said initial solution set in step f) with said new solution set.

3. A method as defined by claim 1 wherein said model includes a plurality of variables, at least some of which interact with one another, and wherein the step of using said model to create said surrogate fitness estimator includes using knowledge of said variable interaction to create said surrogate fitness estimator.

4. A method as defined by claim 1 wherein said model comprises a first model, and wherein the step of using said model to create said surrogate fitness estimator comprises the steps of creating a structural fitness model that represents variable interaction in said first model, and calibrating said structural fitness model.

5. A method as defined by claim 1 wherein the step of identifying a desirable portion of said initial solution set using said fitness calculator produces resulting fitness calculation data points, and wherein the method further includes the step of using said fitness calculation data points to create said fitness surrogate estimator.

6. A method as defined by claim 5 wherein the step of using said fitness calculation data points to create said fitness surrogate estimator comprises using said fitness calculation data points to calibrate said fitness surrogate estimator.

7. A method as defined by claim 5 wherein the method is performed over multiple iterations, wherein the fitness calculator is used to evaluate fitness in at least a plurality of the iterations, and wherein the step of using said fitness calculation data points to create said fitness surrogate estimator comprises using a selected portion of said fitness calculation data points that favors later calculated fitness calculation data points over earlier calculated fitness calculation data points.

8. A method as defined by claim 5 wherein said fitness surrogate estimator includes coefficients, wherein the step of using said data points comprises using said data points to solve for said coefficients through one or more steps of: curve fitting, linear regression, least squares fitting, a heuristic search, a tabu search, and simulated annealing.

9. A method as defined by claim 1 wherein the step of generating said new solutions comprises using said model to create said new solutions.

10. A method as defined by claim 1 wherein the step of creating a model includes creating a probabilistic model that is configured to predict promising solutions, and wherein the step of generating new solutions comprises using said probabilistic model to create said new solutions.

11. A method as defined by claim 1 wherein the step of creating said model comprises creating a first model, and wherein the step of generating new solutions comprises using a second model that is different than said first model to generate said new solutions.

12. A method as defined by claim 1 wherein the step of creating said model includes building one or more of a Bayesian optimization algorithm, an extended compact genetic algorithm, decision trees, probability tables, and a marginal product model.

13. A method for optimizing a solution set as defined by claim 1 wherein said model is a probabilistic model that utilizes local structures to represent conditional probabilities between variables, and wherein the step of creating said fitness surrogate estimator using said model includes using said conditional probabilities between variables to create said fitness surrogate estimator.

14. A method for optimizing a solution set as defined by claim 1 and further including a step of applying decision criteria to determine what portion of said new solution set to evaluate with said fitness surrogate estimator.

15. A method for optimizing a solution set as defined by claim 14 wherein steps of the method are repeated over multiple iterations, and wherein said decision criteria change between said iterations.

16. A method for optimizing a solution set as defined by claim 1 wherein the step of evaluating at least a portion of said new solution set with said fitness surrogate estimator comprises evaluating X % of said new solution set using said fitness surrogate estimator and evaluating the remaining (100-X) % of said new solution set using said fitness calculator to identify said new desirable portion, where X % is at between about 75% and about 99%.

17. A method for optimizing a solution set as defined by claim 1 wherein the step of replacing at least a portion of said initial solution set with said new solutions comprises replacing all of said initial solution set with said new solutions to create said new solution set.

18. A computer program product useful to optimize a solution set, the computer program product comprising computer readable instructions stored on a computer readable memory that when executed by one or more computers cause the one or more computers to perform the following steps, not necessarily in the sequence listed:
a) generate an initial solution set;
b) identify a desirable portion of said initial solution set using a fitness calculator;
c) use said desirable portion to create a model configured to predict other promising solutions, said probabilistic model including a plurality of variables at least some of which interact with one another;
d) use said interactions between said variables to create a surrogate fitness estimator that is computationally less expensive than said fitness calculator;
e) generate new solutions using said probabilistic model;
f) replace at least a portion of said initial solution set with said new solutions to create a new solution set; and
g) evaluate X % of said new solution set using said fitness surrogate estimator and evaluate (100-X) % of said new solution set using said fitness calculator to identify a new desirable portion, where X is between about 75 and 100.

19. A computer program product as defined by claim 18 wherein the program instructions when executed by the one or more computers further cause the one or more computers to perform the step of:
h) determine whether completion criteria are satisfied and if not repeating steps c)-g) until said completion criteria are completed, said step of repeating including replacing said desirable portion in step c) with said new desirable portion and replacing said initial solution set in step f) with said new solution set

20. A method for optimizing a solution set comprising the steps of, not necessarily in the sequence listed:
a) creating an initial solution set;
b) identifying a desirable portion of said initial solution set using a fitness calculator, use of said fitness calculator resulting in fitness calculation data points;
c) storing said fitness calculation data points;
d) using said desirable portion to create a model configured to predict other desirable solutions, said probabilistic model including a plurality of variables at least some of which interact with one another;
e) using said interaction of said variables in said model and said fitness calculation data points to create a surrogate fitness estimator that is computationally less expensive than said fitness calculator;
f) generating new solutions;
g) replacing at least a portion of said initial solution set with said new solutions to create a new solution set; and
h) evaluating X % of said new solution set with said fitness surrogate estimator and the remaining (100-X) % of said second solution set using said fitness calculator to identify a new desirable portion, where X is between about 75 and about 100; and,
i) determining whether completion criteria are satisfied and if not repeating steps d)-h) until said completion criteria are completed, the step of repeating including replacing said desirable portion in step d) with said new desirable portion and replacing said initial solution set in step g) with said new solution set
